(19) United States
(12) Patent Application Publication
(10) Pub. No.: US 2006/0217978 A1
(43) Pub. Date: Sep. 28, 2006

(54) System and method for handling information in a voice recognition automated conversation

(76) Inventors: David Mitby, Mountain View, CA (US); Andrea Klein, Mountain View, CA (US)

Correspondence Address: FAY KAPLUN & MARCIN, LLP, 15O BROADWAY, SUITE 702, NEW YORK, NY, 10038, US

(21) Appl. No.: 11/107,456

(22) Filed: Apr. 15, 2005

Related U.S. Application Data
(60) Provisional application No. 60/665,710, filed on Mar. 28, 2005.

(51) Int. Cl. G10L 15/04

(52) U.S. Cl. 704/251

(57) ABSTRACT

Described is a method of storing a characteristic of an utterance to be received by a speech recognition engine, receiving the utterance from a user, the utterance being received in response to a prompt of an automated conversation, analyzing the received utterance to determine if the utterance conforms to the characteristic and indicating to the user that the utterance conformed to the characteristic.

### PRIORITY/INCORPORATION BY REFERENCE

The present application claims priority to U.S. Provisional Patent Application No. 60/665,710 entitled “System and Method for Handling a Voice Prompted Conversation” filed on Mar. 28, 2005, the specification of which is expressly incorporated, in its entirety, herein.

### BACKGROUND INFORMATION

The automation of information based phone calls such as directory assistance calls may substantially reduce operator costs for the provider. However, users can become frustrated with automated phone calls reducing customer satisfaction and repeat business.

### SUMMARY OF THE INVENTION

A method of storing a characteristic of an utterance to be received by a speech recognition engine, receiving the utterance from a user, the utterance being received in response to a prompt of an automated conversation, analyzing the received utterance to determine if the utterance conforms to the characteristic and indicating to the user that the utterance conformed to the characteristic.

A speech engine including a storage module to store a characteristic of an utterance to be received from a user, a receiving module to receive the utterance from the user, the utterance being received in response to a prompt, an analyzing module to analyze the received utterance to determine if the utterance conforms to the characteristic and an indication module to indicate to the user that the utterance conformed to the characteristic.

A system comprising a memory to store a set of instructions and a processor to execute the set of instructions, the set of instructions being operable to store a characteristic of an utterance to be received by a speech recognition engine, receive the utterance from a user, the utterance being received in response to a prompt of an automated conversation, analyze the received utterance to determine if the utterance conforms to the characteristic and indicate to the user that the utterance conformed to the characteristic.

### BRIEF DESCRIPTION OF DRAWINGS

FIG. 1 shows an exemplary flow for speech processing in an automated conversation according to the present invention.

FIG. 2 shows an exemplary method for speech processing according to the present invention.

FIG. 3 shows an exemplary automated call to a directory assistance service.

FIG. 4 shows an exemplary grammar for a response to a city/state prompt in an automated conversation.

FIG. 5 shows an exemplary fragment of an automated conversation having a city/state prompt and a user's response to the prompt.

FIG. 6 shows an exemplary fragment of a faux grammar 100 for an automated conversation.

FIG. 7 shows an exemplary fragment of an automated conversation including a listing prompt, a response to the listing prompt, a listing re-prompt and a response to the listing re-prompt according to the present invention.

FIG. 8 shows a second exemplary fragment of an automated conversation including a listing prompt, a response to the listing prompt, a listing re-prompt and a response to the listing re-prompt according to the present invention.

FIG. 9 shows an exemplary diagram illustrating a prompt and the potential utterances in response to the prompt.

### DETAILED DESCRIPTION

The present invention may be further understood with reference to the following description and the appended drawings, wherein like elements are provided with the same reference numerals. The present invention is described with reference to an automated directory assistance phone call. However, those of skill in the art will understand that the present invention may be applied to any type of automated conversation. These automated conversations are not limited to phone calls, but may be carried out on any system which receives voice responses to prompts from the system. Furthermore, the terms “speech”, “utterance” and “words” are used with reference to a user's response in this description. Each of these terms is meant to show the sounds which are made by the user to respond to prompts in an automated conversation.

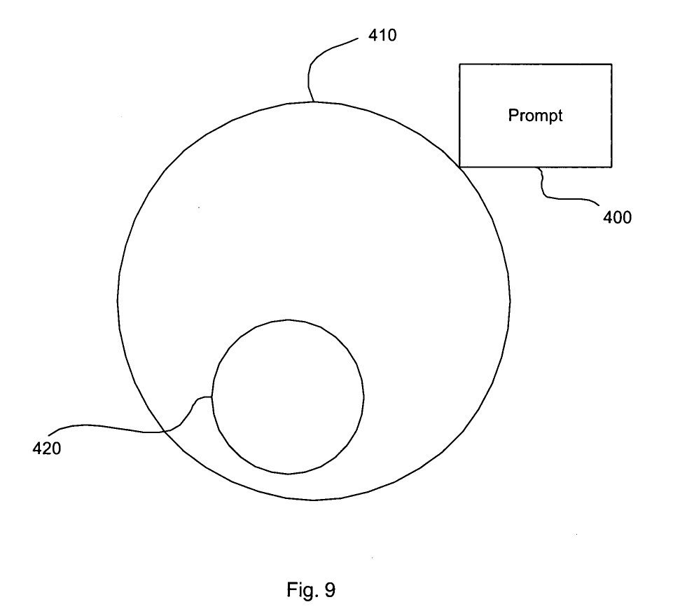

An automated conversation system usually includes a series of prompts (e.g., voice prompts) to which a user will respond by providing a speech input or utterances. The system will then analyze the utterances to determine what the user has said. If the automated conversation system is an automated phone call, the series of prompts may be referred to as the call flow, e.g., prompt 1—response 1—prompt 2—response 2, etc. FIG. 9 shows an exemplary diagram illustrating a prompt 400 and the potential utterances 410 in response to the prompt. The potential utterances 410 include the entire range of possible utterances to the prompt. However, an automated conversation system will not recognize all the potential utterances 410. Thus, region 420 shows the range of utterances which may have a high degree of confidence that the automated conversation system will recognize. This does not mean that all these utterances will be recognized, but that there is a strong possibility they will be recognized. These recognizable utterances 420 may be defined by the characteristics of the utterances. An example of a characteristic may be length of the utterance. For example, the potential utterances 410 may have any length, while the recognizable utterances 420 may have a length that is less than some value. Examples of different manners of determining the length will be provided below. However, it will be appreciated that the recognizable utterances 420 are a subset of the potential utterances 410.

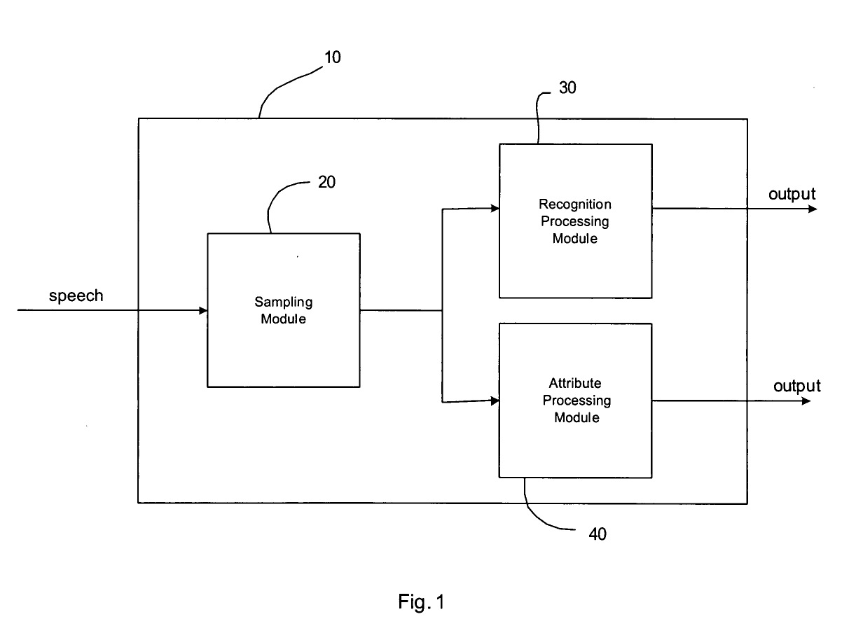

FIG. 1 shows an exemplary flow for speech processing in an automated conversation. The speech is received by an automatic speech recognition (ASR) engine 10. The incoming speech is in the form of an analog signal, i.e., the analog waveform electronic representation of human speech. The speech is initially pre-processed by sampling module 20. The pre-processing may include sampling, analog-to-digital (A/D) conversion, noise suppression, etc. The different types of pre-processing which may be performed on an analog speech signal are well known in the art.

The pre-processed speech signal may then be routed to a recognition processing module 30 and an attribute processing module 40. The recognition processing module 30 will process the speech signal to determine the content of the speech signal, i.e., what the person said. For example, the recognition processing module 30 may determine that the person stated “yes” in response to a prompt. For those more interested in understanding how the recognition processing module 30 recognizes human speech, they are referred to “Speech and Language Processing: An Introduction to Natural Language Processing, Computational Linguistics and Speech Recognition” by Daniel Jurafsky and James H. Martin. The output of the recognition processing module 30 may then be sent to other system modules for further processing. This further processing will be described in greater detail below.

The pre-processed speech signal may also be routed to the attribute processing module 40 to determine attributes of the speech signal. The attributes of the speech signal may be considered to be parameters or characteristics which are unrelated to the grammatical meaning of the speech. As described above, the recognition processing module 30 will determine the grammatical meaning (i.e., what the person said). The attribute processing module 40 may determine attributes of the speech signal itself, for example, the length of the signal, the amount of noise in the signal, the amplitude of the signal, etc. The output of the attribute processing module 40 may be the attributes associated with the input speech signal which may be sent to other system modules for further processing. This further processing will be described in greater detail below.

The ASR engine 10, as part of an overall system for automated conversations, is used to recognize the speech input by a user of the system. If the speech is completely recognized, the system will generally progress the user through a series of prompts to arrive at the desired result for the user, e.g., the system may output a telephone listing desired by the user. However, there are many instances where a user inputs speech which is an inappropriate response to the prompt provided by the system or the input speech signal experiences some type of problem (e.g., noise). The exemplary embodiments of the present invention are directed at systems and methods for identifying problems with the user's response and allowing the system to aid the user in correcting the response.

The outputs of the recognition processing module 30 and the attribute processing module 40 may be used to identify the type of inappropriate response and allow the system to provide the user with a new or additional prompt that allows the user to correct the response. For example, the attribute processing module 40 may determine that the speech signal has a certain duration. The attribute processing module 40 (or a further processing module) may have information that the duration of the response is very long compared to the expected duration of the response (e.g., the prompt requested a yes/no answer and the duration of the response was significantly longer than an expected duration for either yes or no). In such a case, the system may provide the user with a new prompt to correct the problem, e.g., a prompt stating “please respond by stating yes or no only.” Other attributes of the speech signal generated by the attribute processing module 40 may be used in a similar manner. Each attribute may be associated with one or more categories of problems. The category of problem may then correspond to a particular corrective action that may be taken by the system.

The output of the recognition processing module 30 may be used in a similar manner to identify problems with a response. In such a circumstance, the recognition processing module 30 may determine the content of the speech, but the content does not match the expected response. As will be described in greater detail below, the recognition processing module 30 may include a grammar which includes words or other utterances which may be recognized by the recognition processing module 30, but the recognized response is inappropriate. In the same manner as described above for the speech attributes, the recognized response may be output by the recognition processing module 30 and categorized as a particular type of problem. The system may then take a corrective action corresponding to the categorized problem.

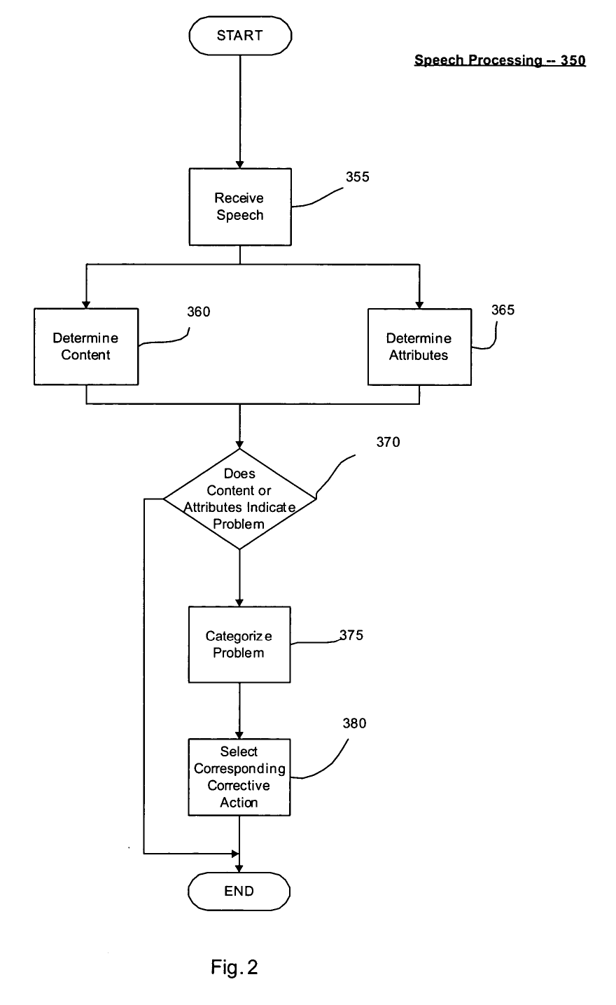

FIG. 2 shows an exemplary method 350 for speech processing. In step 355, the speech to be processed is received by, for example, the ASR engine 10 of FIG. 1. The ASR engine 10 may perform the pre-processing on the speech signal as described with respect to the sampling module 20. The method then continues to steps 360 and 365 for the determination of the content and attributes, respectively. As described above, the content of the speech signal is determined by, for example, the recognition processing module 30 and the attributes are determined by, for example, the attribute processing module 40.

After the content and attribute information is extracted from the speech signal, this information is used in step 370 to determine whether there are any problems with the response. Some examples of problems with responses were described above and additional examples will be provided below. If there are no problems based on the content or attributes of the speech signal, the method will be complete because the system will have recognized the speech as an appropriate response to the prompt and take the appropriate action based on the recognized response. However, if there is a problem with the response based on the content or attribute of the speech signal, the method will continue to step 375 where the problem will be categorized. There are numerous categories of problems which may be identified based on the content (e.g., too many recognized, but low priority utterances, etc.) and attributes (e.g., response too long, response too short, too much noise in response, amplitude of signal too low, etc.).

After the problem has been categorized in step 375, the method continues to step 380 where the system will select the corrective action which corresponds to the category of problem identified in the speech signal. Again, there are numerous types of corrective actions that may correspond to the identified problem category, e.g., re-prompt with previous prompt, re-prompt with new prompt, change selected grammar for the recognition processing module 30, attempt different type of noise cancellation, raise volume of incoming signal, etc. The system may implement the selected corrective action and the method is then complete. Those of skill in the art will understand that the method 350 may be carried out for each response (or speech signal) received by the system.

In the method 350 of FIG. 2 and in the schematic representation of FIG. 1, the content and attribute recognition for a speech signal are shown as occurring simultaneously. However, those of skill in the art will understand that the attribute recognition may occur before, after or at the same time as the content recognition. For example, the attribute processing module 40 may be placed before the recognition processing module 30 so that the attributes of the speech signal are determined prior to the content. This may be advantageous because the attribute processing module 40 may identify a problem with the speech signal that makes it unlikely that the recognition processing engine 30 will recognize an appropriate response from the speech signal. Continuing with the example above where the attribute processing module 40 identified the speech signal as being too long for a yes/no type response, the ASR engine 10 may use this attribute information and determine that the recognition processing module 30 may not be able to determine the content of the speech, because it was merely expecting a yes or no response. The ASR engine 10 may determine that the speech signal will not be sent to the recognition processing module 30 because the processing power/time will be wasted in attempting to determine inappropriate content. The system may take corrective action based solely on the determined attributes of the speech signal.

In another example, the attribute processing module 40 may determine that the speech signal includes an excessive amount of noise. Once again, the ASR engine 10 may use this attribute information to determine that the speech signal should not be sent to the recognition processing module 30 because it would be unlikely that the content would be determined from a noisy signal. These examples also point out that the attribute processing module 40 may receive the speech signal without the benefit of the pre-processing of the sampling module 20 or may have a separate pre-processing module from the pre-processing module used for the recognition processing module 30.

In an alternative example, the attribute processing module 40 may be placed after the recognition processing module 30 so that attributes of the speech signal are determined after the content is determined. This arrangement may be advantageous because, if the recognition processing module 30 is able to determine the content of the speech signal, and that content is an appropriate response, the ASR engine 10 may determine that the processing of the speech signal by the attribute processing module 40 is not necessary. In addition, if the ASR engine 10 determines the problem with the response using only the content identified by the recognition processing module 30, the ASR engine 10 may also determine that the processing of the speech signal by the attribute processing module 40 is not necessary in this situation. Thus, the time and processing requirements for the attribute processing module 40 may be saved.

The ASR engine 10 is shown as including modules 20, 30 and 40. Those of skill in the art will understand that each of these modules may include additional functionality to that described herein and the functionality described herein may be included in more or less modules of an actual implementation of an ASR engine. Furthermore, the ASR engine 10 may include additional functionality, e.g., the entire system described above may be included in the ASR engine 10.

The following provides an exemplary implementation of the exemplary system and method for providing corrective actions in an automated conversation. The exemplary implementation is a directory assistance (“DA”) service providing phone listings to users. The DA service includes an ASR engine implementing the functionality of the exemplary recognition processing module 30 and attribute processing module 40. The DA service 30 also includes a database or a series of databases that include the listing information. These databases may be accessed based on information provided by the user in order to obtain the listing information requested by the user.

The general operation of the DA service will be described with reference to the exemplary conversation 50 illustrated by FIG. 2. The prompts provided by the DA service are indicated by “Service:” and the exemplary responses by the user are indicated by “User:.” This exemplary conversation 50 may occur, for example, when a user dials “411 information” and is connected to the DA service. The user is initially provided with branding information for the DA service as shown by line 52 of the conversation 50. The next line 54 of the conversation 50 is a voice prompt to query the user as to the city and state of the desired listing.

On line 56 of the conversation 50, the user responds to the voice prompt of line 54. In this example, the user says “Brooklyn, New York” and this speech is presented to the ASR engine of the DA service (e.g., ASR engine 300). As described above, the ASR engine may determine the content of the speech, i.e., the speech signal corresponds to the content of Brooklyn, New York. The DA service then generates a further voice prompt in line 58 based on the information provided by the city/state response in line 56. The voice prompt in line 58 prompts “What listing?” On line 60 of the conversation 50, the user responds to the voice prompt of line 58. In this example, the user says “Joe's Pizza” and the ASR engine recognizes the speech as corresponding to a listing for Joe's Pizza. The ASR engine provides this content information to the DA service which searches for the desired listing. For example, the automated call service may access a database associated with Brooklyn, New York and search for the listing Joe's Pizza. The DA service then generates a listing such as that shown in line 62 of the conversation 50.

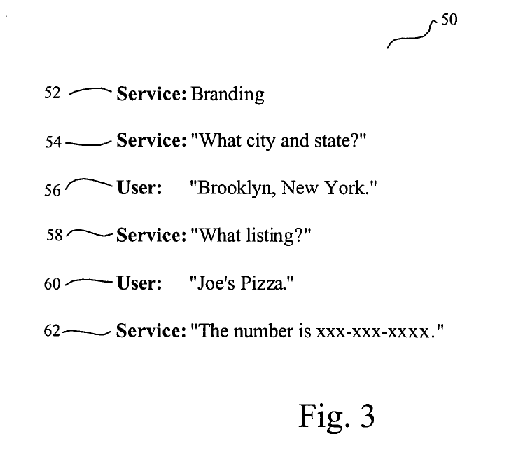

The conversation 50 of FIG. 3 may be considered an ideal conversation because there was no problems with the speech input by the user. However, as described above, the speech input by the user may have problems which prevents the ASR engine from recognizing the response as a valid response to a system prompt. The exemplary embodiment of the present invention provides for the DA service to take corrective actions based on the content or the attributes of the input speech signal. The exemplary corrective action described in a first embodiment of the DA service is smart re-prompting of the user. When the speech input by the user has a problem, the DA service may re-prompt the user. However, this re-prompting does not need to be in the exact same format as the initial prompt. The re-prompt may include additional information or be in a different format that addresses the deficiencies in the user's response to the initial prompt. The exemplary embodiments of the present invention provides for this smart re-prompting of user's based on the content and/or attributes of the initial response.

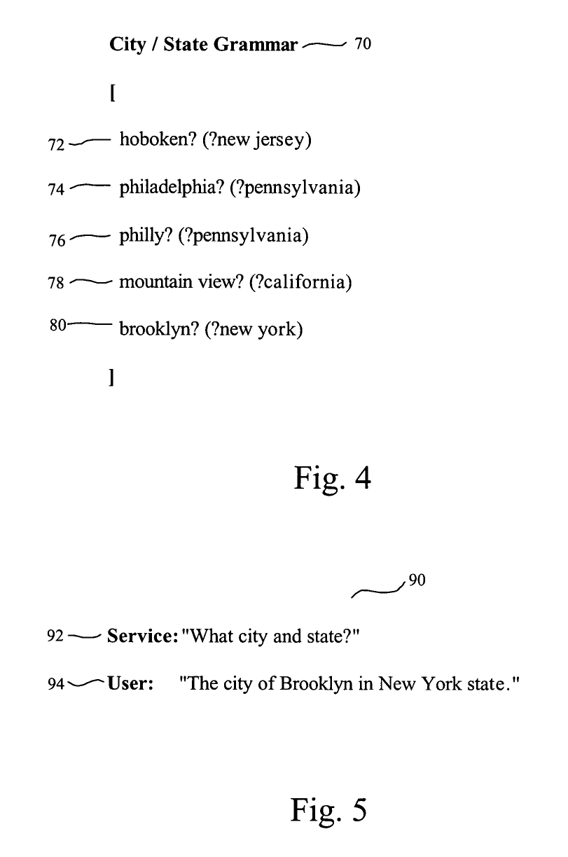

In an automated conversation system, the expected responses to the prompts may form a grammar for the ASR engine which is defined as a formal definition of the syntactic structure of a response and the actual words and/or sounds which are expected to make up the response. The grammar may be used by the ASR engine to parse a response to determine the content of the user's response. FIG. 4 shows an exemplary grammar 70 for a response to a city/state prompt in an automated conversation. As shown in line 54 of conversation 50 in FIG. 3, the DA service provides the user with a city/state prompt and the user responded in line 56 with a response in the form of a city name followed by a state name, i.e., Brooklyn, New York. The ASR engine may be configured with a grammar to recognize responses in the form a city name followed by a state name, e.g., the expected syntax of a response is city name/state name. The grammar 70 of FIG. 4 shows this type of grammar.

The grammar 70 shows a first exemplary entry 72 which has an expected grammar for a response of Hoboken, New Jersey to the city/state prompt. Thus, if a user were to respond to the city/state prompt with a response of Hoboken, New Jersey, the ASR engine would recognize this response and indicate to the DA service that the content of the user's response corresponded to a desired city/state of Hoboken, New Jersey. The DA service may then provide the next prompt of the automated conversation to the user, e.g., the listing prompt. The grammar 70 shows additional entries 74-80 having city/state responses corresponding to Philadelphia, Pennsylvania, Philly, Pennsylvania, Mountain View, California Brooklyn, New York, respectively. The entries 74 and 76 show that a single city, e.g., Philadelphia, may have multiple grammar entries because users may use slang or other alternate names for the same city.

However, users do not always provide responses in the expected manner or in the exact syntax which the ASR engine is expecting. FIG. 5 shows an exemplary fragment of an automated conversation 90 which shows a city/state prompt in line 92 and a user's response to the prompt in line 94. As shown in line 94, the user did not respond by merely stating the city and state, e.g. Brooklyn, New York, but rather provided a complete sentence in response to the prompt, i.e., “The city of Brooklyn in New York State.” This is just one example of a response which is not in the exact syntax which is expected by the ASR engine. Those of skill in the art will understand that there is no limit to the types of responses which may be provided by a user.

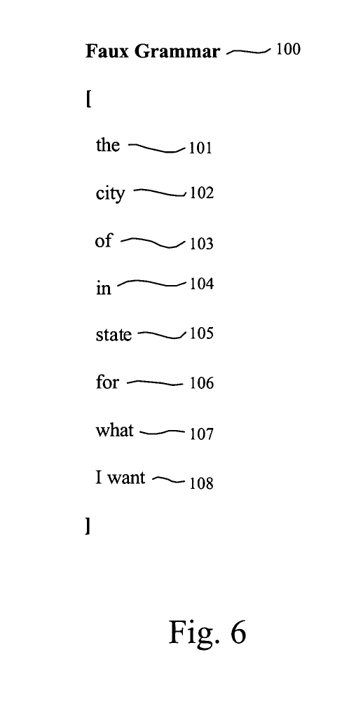

One exemplary manner of handling this non-standard syntax is by also providing an additional grammar which includes expected faux responses to the prompt. FIG. 6 shows an exemplary fragment of a faux grammar 100. The faux grammar 100 includes entries 101-108 of the words and/or phrases which the designer and/or operator of the DA service expect in response to the prompts. This grammar is in addition to, or in the alternative to, the expected syntax or content of the response. The faux grammar may be considered identifiable, but low or no priority, content. Thus, in the exemplary response in line 94, the ASR engine may recognize Brooklyn and New York from the grammar 70 and the additional words in the response from the faux grammar 100, i.e., the, city, of, in, state. When the ASR engine recognizes this grammar in addition to a valid city/state response, e.g., Brooklyn, New York, the ASR engine may disregard these portions of the response.

There may be other responses which are provided by the user which do not include a valid city/state response. For example, the user may simply respond to the city/state prompt by asking “what?” The faux grammar 100 may also be used to handle this situation. The entry 107 of faux grammar 100 is “what.” The ASR engine may recognize this speech by the user and inform the DA service that the user content of the user response was the question “what?” in response to the city/state prompt. The DA service may be programmed to replay the city/state prompt when the user asks this question. Thus, the faux grammar 100 may be used in a variety of manners to help determine the action that is taken by the DA service based on the response of the user.

The faux grammar 100 may be an example of the ASR engine identifying the content of the speech signal, but not identifying the information that was meant to be conveyed by the speech. For example, the recognition processing module of the ASR engine may identify a plurality of faux responses in the speech signal based on the faux grammar 100. The recognition processing module may output the content or the number of instances of faux content in the response. As described above, the ASR engine may then identify a problem with the response based on the faux content or the number of instances of faux content in the response. The DA service may then take the appropriate corrective action based on the identified problem. An example will be provided below.

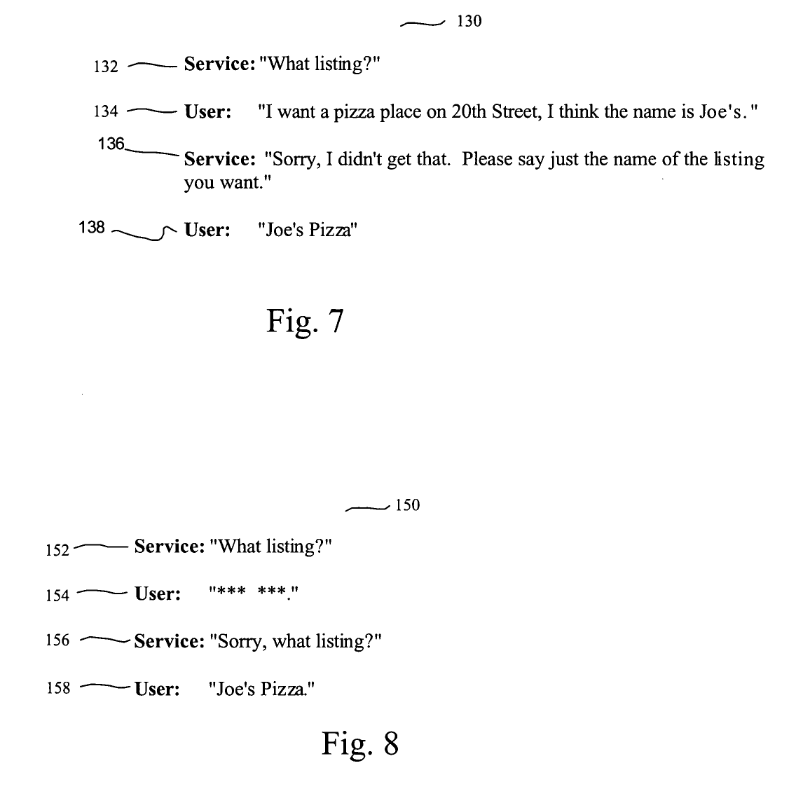

FIG. 7 shows an exemplary fragment of an automated conversation 130 which provides an example of a smart re-prompting of a user based on the content of the user's response. In line 132, the DA service prompts the user to provide the name of the listing. In line 134, the user responds with an entire sentence, i.e. “I want a pizza place on 20^{th} Street, I think the name is Joe's.” The recognition processing module of the ASR engine may process the speech signal corresponding to this sentence and be unable to recognize the listing. However, the recognition processing module may recognize multiple faux grammar entries, e.g., I, want, a on, think, the, etc. This information is provided to the ASR engine which may include information that categorizes the identification of more than a certain number of faux grammar entries (e.g., five) in a response as a response with too much information. This category of problem response may correspond to a corrective action (e.g., a smart re-prompt) of providing a prompt which instructs the user to provide only the listing information as shown in line 136, e.g., “Sorry, I didn't get that. Please say just the name of the listing.” The user may then understand the problem with the initial response (line 134) and provide a new response in line 138 which provides just the name of the listing. Thus, the conversation 130 of FIG. 7 shows an example of where identified content may be used to provide corrective action for a problem with the user's response.

As described above, an attribute of the speech may also be used to determine the problem with the response. An example of an attribute may be the duration of the response. Thus, the attribute processing module of the ASR engine may determine the duration of each speech signal and categorize the speech signals based on these durations. For example, it may be determined that when a short response is provided, the user may have the correct syntax for the response, but did not provide enough information in the response. The re-prompt may be short and may simply be a repeat of the initial prompt. FIG. 8 shows an exemplary fragment of an automated conversation 150 which includes a listing prompt 152 and a response 154. The *** *** of the response indicates that the recognition processing module was unable to identify the content of the speech. However, the attribute processing module may identify that the response 152 was very short in duration, for example, by measuring the number of utterances or time duration. The ASR engine may have instructions which indicate that short responses should be re-prompted with a short re-prompt such as “Sorry, what listing?” as shown in line 156. The user may then respond in line 158 with a repeat of the listing which the ASR engine fully recognizes, e.g., “Joe's Pizza.” Thus, the attribute of the utterance, i.e., the length of the utterance, determines the re-prompt which is presented to the user.

Referring back to FIG. 7, instead of using the number of faux responses identified by the recognition processing module, the attribute processing module may identify the long duration of the response 134. The ASR engine may include instructions that when a long response is provided, the user did not use the correct syntax and a more informative re-prompt should be used. Thus, the re-prompt of line 136 may be provided for long duration responses. The example of FIG. 7 shows that there may be cases where either an attribute or the content of the speech signal may be used to provide a corrective action.

In the above examples, it can be seen that the utterance attribute based re-prompting may contribute to the overall satisfaction that the customer feels when using the DA service. In the example of FIG. 8, the length attribute indicated that the user was very close to the correct syntax. Thus, if the user in automated conversation 150 were to receive the re-prompt 136 of conversation 130, this user may have become frustrated with the automated conversation because they may have considered that the only information provided was the listing. Conversely, the user in the second example of conversation 130 of FIG. 7 may have provided the longer response 134 for a variety of reasons, e.g., the user did not completely understand the initial listing prompt 132. Thus, the longer re-prompt 136 may have provided the user with additional information which allowed the user to provide the updated response 138 in the correct syntax. Those of skill in the art will understand that the smart re-prompting based on the attributes of the utterance is not a guarantee that the user will respond correctly to the re-prompt, but it may provide greater customer satisfaction because the re-prompt is aimed at solving the problem with the initial response provided by the user.

Those of skill in the art will also understand that other attributes or a combination of attributes and content may be used to determine a proper re-prompt. For example, a response may include speech where the content is partially recognized, e.g., identifiable and unidentifiable utterances. The ASR engine may be configured to determine the number of unintelligible utterances compared to the identifiable utterances and provide re-prompts based on this comparison. Any attribute which can be determined from the utterance of the user may be used as a factor in determining the type of re-prompt that is presented to the user.

In addition, different attribute/content information may be combined in different manners to form the basis for various re-prompts. Thus, a short response that is completely unintelligible may be treated differently than a short response that has some discernable grammar. Furthermore, the number of different types of re-prompts is not limited. In the example provided above of the duration based re-prompt, the responses were characterized as being short or long duration responses. In another example, the responses may be characterized as short, medium or long duration responses. Each of these categories may have a different corresponding re-prompt.

In the examples provided, the smart re-prompt was described with reference to the listing state. However, the smart re-prompt may also be implemented in the locality state. Where the automated conversation is not a DA service, the exemplary embodiment of the smart re-prompt may be implemented in any of the states of the automated conversation. For example, if the automated conversation is a phone banking related application, there may be transaction type state, e.g., the automated system prompts the user as to the type of transaction that the user desires to perform such as balance requests, money transfers, etc. The smart re-prompt may be implemented in this state or any other state of the banking application. The automated conversation may not be a phone call related conversation. For example, a retail store may have a device that provides automated conversations for its customers related to, for example, product checks, store directories, returns, etc. The smart re-prompt may be implemented in any prompting state of this type of device.

The present invention has been described with the reference to the above exemplary embodiments. One skilled in the art would understand that the present invention may also be successfully implemented if modified. Accordingly, various modifications and changes may be made to the embodiments without departing from the broadest spirit and scope of the present invention as set forth in the claims that follow. The specification and drawings, accordingly, should be regarded in an illustrative rather than restrictive sense.

What is claimed is:

1. A method, comprising:
storing a characteristic of an utterance to be received by a speech recognition engine;
receiving the utterance from a user, the utterance being received in response to a prompt of an automated conversation;
analyzing the received utterance to determine if the utterance conforms to the characteristic; and
indicating to the user that the utterance conformed to the characteristic.

2. The method of claim 1, wherein the characteristic is indicative that the utterance is unrecognizable by the speech engine.

3. The method of claim 1, wherein the characteristic is a length of the utterance.

4. The method of claim 3, wherein the length is determined by one of a word content of the utterance and a length of a speech signal corresponding to the utterance.

5. The method of claim 1, wherein the characteristic includes a plurality of characteristics.

6. The method of claim 1, wherein the indication to the user is providing a re-prompt to the user.

7. The method of claim 6, wherein the re-prompt corresponds to the characteristic.

8. The method of claim 1, wherein the characteristic includes one of a duration of the utterance, an amount of noise in a speech signal corresponding to the utterance, an amplitude of the speech signal, a number of unrecognized words in the utterance and a spectral parameter of the speech signal.

9. The method of claim 1, wherein the automated conversation is an automated phone call.

10. A speech engine, comprising:
a storage module to store a characteristic of an utterance to be received from a user;
a receiving module to receive the utterance from the user, the utterance being received in response to a prompt;
an analyzing module to analyze the received utterance to determine if the utterance conforms to the characteristic; and
an indication module to indicate to the user that the utterance conformed to the characteristic.

11. The speech engine of claim 10, wherein the characteristic is indicative that the utterance is unrecognizable by the speech engine.

12. The speech engine of claim 10, wherein the analyzing module includes a recognition processing module receiving the utterance and identifying a content of the utterance.

13. The speech engine of claim 10, wherein the analyzing module includes an attribute processing module receiving the utterance and identifying an attribute in the utterance.

14. The speech engine of claim 10, wherein the indication module provides a re-prompt to the user as an indication that the utterance conformed to the characteristic.

15. The speech engine of claim 14, wherein the re-prompt corresponds to the characteristic.

16. The speech engine of claim 10, wherein the characteristic includes one of a duration of the utterance, an amount of noise in a speech signal corresponding to the utterance, an amplitude of the speech signal, a number of unrecognized words in the utterance and a spectral parameter of the speech signal.

17. The speech engine of claim 10, wherein the prompt is part of an automated phone call.

18. The speech engine of claim 10, further comprising:
a pre-processing module to pre-process the utterance.

19. The speech engine of claim 10, wherein the prompt is part of a directory assistance service.

20. A system comprising a memory to store a set of instructions and a processor to execute the set of instructions, the set of instructions being operable to:
store a characteristic of an utterance to be received by a speech recognition engine;
receive the utterance from a user, the utterance being received in response to a prompt of an automated conversation;
analyze the received utterance to determine if the utterance conforms to the characteristic; and
indicate to the user that the utterance conformed to the characteristic.
